(19) United States
(12) Patent Application Publication
(10) Pub. No.: US 2016/0019492 A1
(43) Pub. Date: Jan. 21, 2016

(54) CHARGE STATION QUEUE MANAGEMENT

(71) Applicant: EV Connect, Inc., Culver City, CA (US)

(72) Inventors: Bradley Juhasz, Glendale, CA (US); Gavin Minami, Marina Del Rey, CA (US)

(21) Appl. No.: 14/335,757

(22) Filed: Jul. 18, 2014

(51) Int. Cl. G06Q 10/06; G06Q 50/06; G06Q 20/14

(52) U.S. Cl. CPC G06Q 10/063114; G06Q 20/145; G06Q 50/06

(57) ABSTRACT

There is disclosed a method and a system for management of electric vehicle charging station queues. The method includes maintaining a plurality of requests to utilize the electric vehicle charging station in a queue defining an order of electric vehicles to be charged at the electric vehicle charging station and sensing that a charging vehicle at an electric vehicle charging station and associated with a first vehicle operator has completed a charging process. The method further includes notifying the first vehicle operator that the charging process is completed and providing an allotted vacation time period in which the first vehicle operator may vacate the charging vehicle from the electric vehicle charging station and increasing the cost associated with continued charging of the charging vehicle if the charging vehicle is not vacated from the electric vehicle charging station within the allotted vacation time.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent is related to the following co-pending applications:

U.S. patent application Ser. No. 13/693,839 filed Dec. 4, 2012 and entitled “ELECTRIC VEHICLE CHARGING STATION, SYSTEM, AND METHODS”.

U.S. patent application Ser. No. 13/670,347 filed Nov. 6, 2012 and entitled “QUEUE PRIORITIZATION FOR ELECTRIC VEHICLE CHARGING STATIONS”.

U.S. patent application Ser. No. 13/670,352 filed Nov. 6, 2012 and entitled “MANAGEMENT OF ELECTRIC VEHICLE CHARGING STATION QUEUES”.

PCT application number PCT/US13/68203 filed Nov. 4, 2013 and entitled “ELECTRIC VEHICLE CHARGING STATION, SYSTEM, AND METHODS”.

PCT application number PCT/US13/68201 filed Nov. 4, 2013 and entitled “QUEUE PRIORITIZATION FOR ELECTRIC VEHICLE CHARGING STATIONS”.

PCT application number PCT/US13/68202 filed Nov. 4, 2013 and entitled “MANAGEMENT OF ELECTRIC VEHICLE CHARGING STATION QUEUES”.

### BACKGROUND

1. Field

This disclosure relates to the management of electric vehicle charging stations queues.

2. Description of the Related Art

The owners of plug-in electric and hybrid electric vehicles, which will be referred to herein as PEVs, typically have a dedicated charging station at the home or other location where the vehicle is normally garaged. However, without the existence of an infrastructure of public charging station, the applications for PEVs will be limited to commuting and other short-distance travel. In this patent, a charging station is considered “public” if it is accessible and usable by plurality of drivers, as opposed to a private charging station located at a PEV owner's home. A “public” charging station is not necessarily accessible to any and all PEVs. Public charging stations may be disposed, for example at commercial buildings, shopping malls, multi-unit dwellings, governmental facilities and other locations.

In the U.S., charging stations usually comply with the Society of Automotive Engineers (SAE) standard, SAE J1772™. This standard refers to charging stations as “electric vehicle support equipment”, leading to the widely used acronym EVSE. However, since the only support actually provided by an EVSE is charging, this patent will use the term electrical vehicle charging station or EVCS.

Typically, EVCS are first-come, first-served. That is, the first user that arrives at an EVCS may use the station and continue to use the EVCS until that user decides to leave. This rewards early arrivals at locations and is typical for normal parking spaces. However, this results in a sub-optimal allocation of the few EVCS typically available in most locations.

For example, a user can leave his or her home fully-charged and arrive at a destination with nearly-full batteries. The user may then park at an EVCS and begin charging his or her electric vehicle. The electric vehicle may be fully charged within one to three hours, but the user's car may remain in the spot for the remainder of the day. Meanwhile, other individuals with electric vehicles who arrived later or with lower battery charge levels are unable to access the EVCS.

### DESCRIPTION OF THE DRAWINGS

FIG. 1 is a block diagram of an environment for charging an electric vehicle.

FIG. 2 is a block diagram of an electric vehicle charging station (EVCS) cloud.

FIG. 3 is a block diagram of a computing device.

FIG. 4 is a block diagram of an EVCS.

FIG. 5 is a block diagram of a personal computing/communications device.

FIG. 6 is a flowchart for a process of joining an EVCS queue.

FIG. 7 is a flowchart for a process of handling a completed electric vehicle charge.

FIG. 8 is a flowchart for a process of queue transition handling.

FIG. 9 is a flowchart for a process of dealing with a missed EVCS reservation.

FIG. 10 is an example queue.

FIGS. 11A and 11B are notifications to a vehicle operator in an EVCS.

FIGS. 12A, 12B, 12C, 12D and 12E are notifications to a vehicle operator in an EVCS queue.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

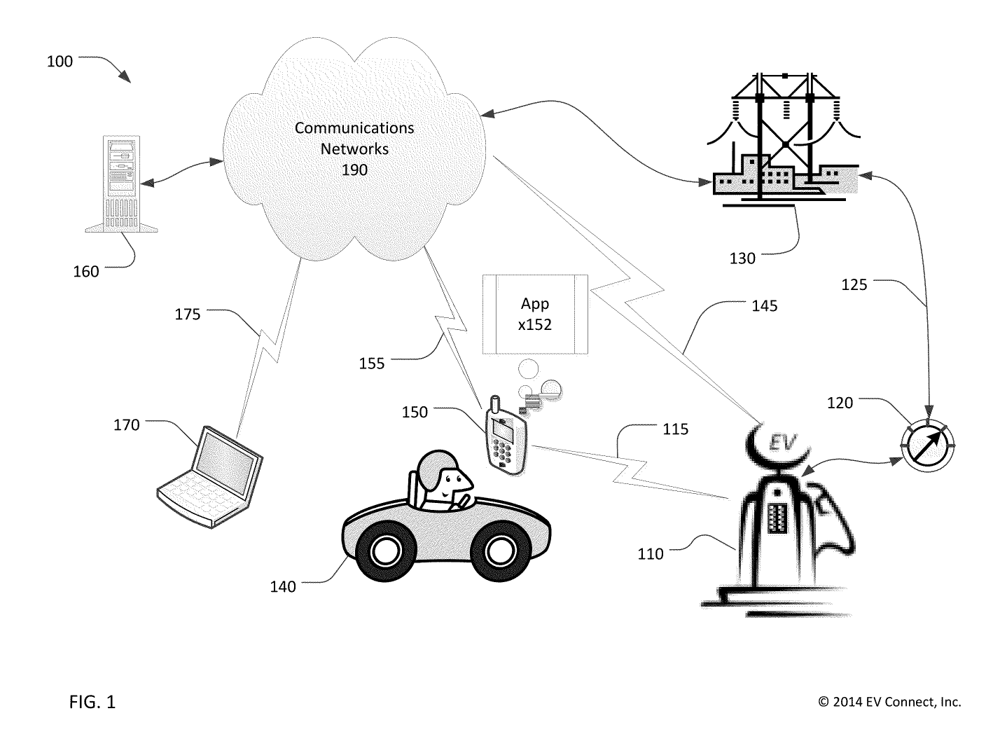

Referring now to FIG. 1, an environment 100 for charging an electric vehicle 140 may include an EVCS 110 connected to a utility grid 130 via a meter 120. The EVCS may communicate with a driver's personal communications device (PCD) 150 over a first wireless communications path 115. The PCD may, in turn, connect to a network 190 over a second wireless communication path 155. The first wireless communications path 115 may use, for example, Bluetooth™, ZigBee™, or some other short-range wireless communications protocol. The second communications path 155 may use, for example, WiFi™ or a cell phone data communications protocol to connect to the network 190. The PCD 150 may be, for example, a smart phone, a tablet computer, a laptop computer, a computer operating as a part of the PEV or some other device capable of communicating with the EVCS 110 and the network 190.

The PCD 150 may run or access an application, or “app”, 152 that enables the PCD to serve as a user interface for the EVCS 110. This app 152 may be web-based or compiled for use on the PCD. The EVCS 110 and the network 190 may communicate using a third communications path 145. This third communications path 145 may be wireless, as described above, or wired. If the third communications path 145 is wired, it may rely upon TCP/IP protocols, proprietary protocols, or protocols based upon the OSI model. In some situations, the PCD 150 running the app 152 may also function as a bridge to provide bidirectional communications between the EVCS 110 and the network 190.

A server 160 may manage a network of vehicle charging stations including the EVCS 110. The server 160 may monitor the operation of the EVCS 110. The server 160 may manage billing and/or cost allocation for the use of the EVCS 110. The server 160 may manage an authorization system to limit access to the EVCS 110 to only authorized vehicles or drivers. The server 160 may also manage a reservation or queue system to allow authorized drivers to reserve future use of the EVCS 110. The server 160 may communicate with the EVCS 110 via the network and the third communications path 145. The server 160 may communicate with the EVCS 110 via the network and the PCD 150. In this case, communications between the server 160 and the EVCS 110 may be intermittent and only occur when a PCD 150 running the app 152 is present.

A vehicle operator may communicate with the server 160 using their PCD 150 or using another computing device such as a personal computer 170 coupled to the network 190 by a wired or wireless communications path 175. The driver may communicate with the server 160, for example, to establish an account, to provide billing information, to make a reservation, or for some other purpose. Throughout this patent, the terms “vehicle operator” and “driver” are synonymous and refer to the current operator of a motor vehicle.

The meter 120 may be a conventional electric utility meter or a so-called “smart meter” that communicates with the utility grid 130 and the EVCS 110. The EVCS 110 may communicate with a smart meter 120, when present, using the same wireless protocol used to communicate with the PCD 150 or a different wireless communications protocol. The EVCS may communicate with the smart meter 120 using a power line communications (PLC) protocol such as, for example, the IEEE 1901 protocol.

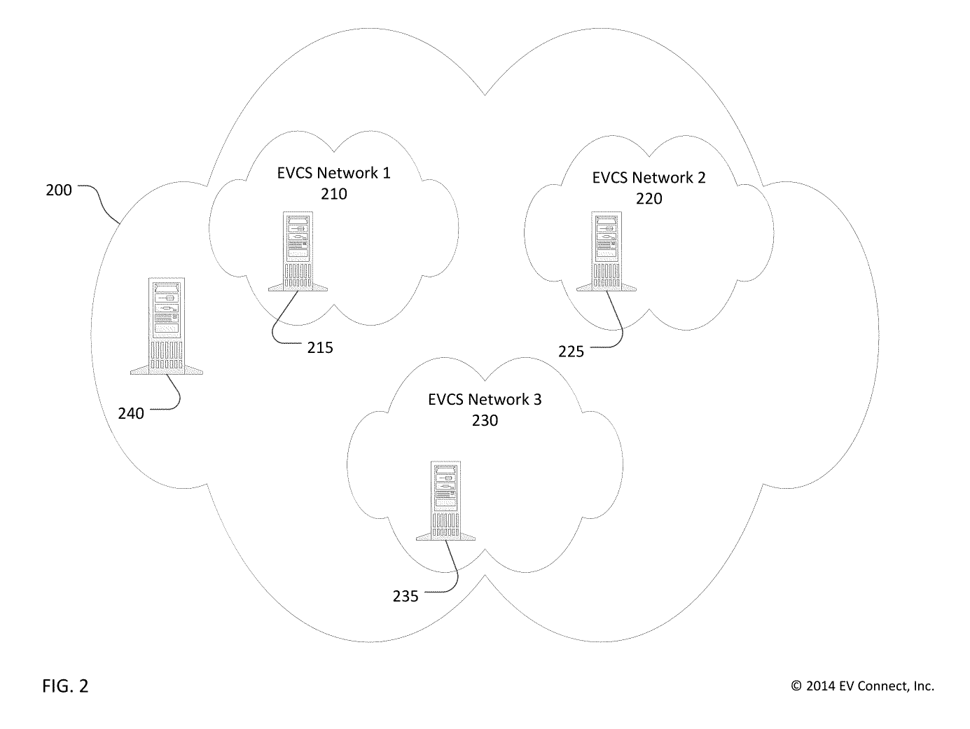

Referring now to FIG. 2, a cloud 200 may support a plurality of EVCS management networks, each of with may operate, for example, as a virtual private network within the cloud 200. Three EVCS management networks 210, 220, 230 are shown in this example. A network may contain more or fewer than three EVCS management networks. Each of the EVCS management networks may be owned or operated by different business entities such as, for example, electric utility companies and manufacturers of EVCS equipment. The cloud 200 may include a physical or virtual server 240 to manage interactions between the EVCS management networks 210, 220, 230.

Each EVCS management network 210, 220, 230 may include one or more EVCS operating at respective locations. Each EVCS management network 210, 220, 230 may include a respective server 215, 225, 235 to manage access, billing, and queuing for the one or more EVCS within the network.

The server 240 may communicate with each of the EVCS management networks 210, 220, 230. The server 240 may manage transactions between the EVCS management networks 210, 220, 230. For example, a customer or member of EVCS management network 1 210 may be at a location remote from any EVCS in EVCS management network 1, and may need to access an EVCS within another EVCS management network. The customer may communicate with server 215 with in EVCS management network 1 210 to request access to an “out of network” EVCS. The servers 215 may then communicate with server 225 and/or server 235 via server 240 to gain customer access to an EVCS within EVCS management network 2 220 or EVCS management network 3 230. Billing and payments for access to the out-of-network EVCS may be processed via the server 240.

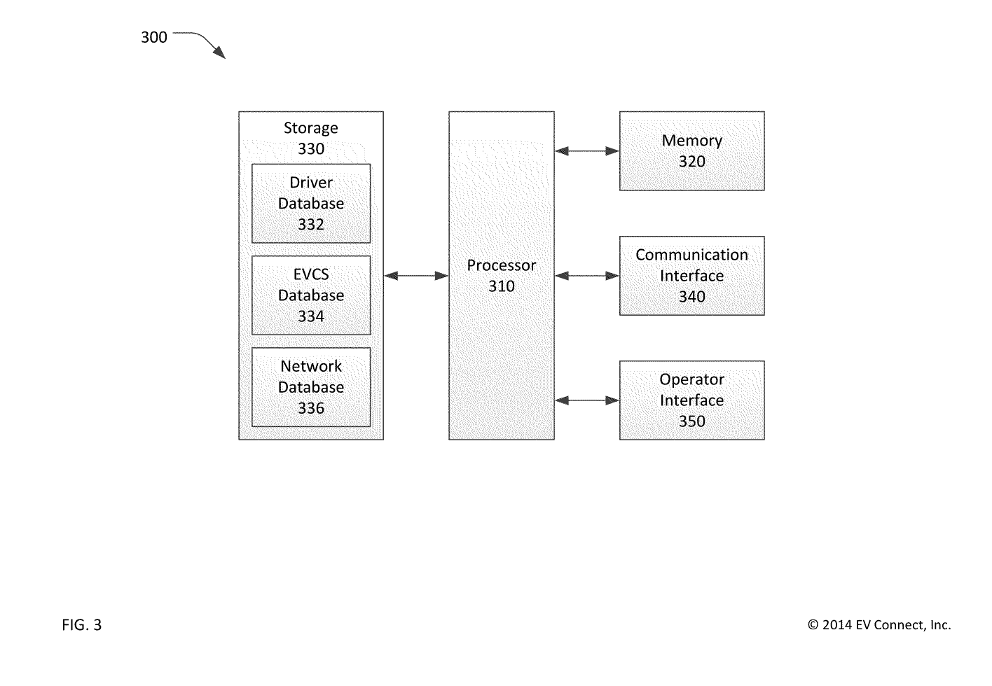

Turning now to FIG. 3, a block diagram of a computing device 300 is shown. The computing device 300 may be, for example, the server 160 of FIG. 1 or the servers 215, 225, 235 or 240 of FIG. 2. The computing device 300 includes a processor 310, memory 320, storage 330, a communication interface 340 and an operator interface 350. The storage 330 includes a driver database 332, an EVCS database 334 and a network database 336.

The processor 310 may include hardware, which may be augmented by firmware, for providing functionality and features described herein. The processor 310 may include one or more processor circuits such as microprocessors, digital signal processors, and graphic processors. The processor 310 may include other circuits such as logic arrays, analog circuits, and/or digital circuits.

The memory 320 may include static or dynamic random access memory, read-only memory, and/or nonvolatile memory such as flash memory. Information stored in the memory may includes a BIOS (basic input/output system) to initialize the processor 310, interim and final test data, and other data relating to ongoing operation of the processor 310.

The storage 330 may include one or more storage devices. As used herein, a “storage device” is a device that allows for reading and/or writing to a storage medium. These storage media include, for example, magnetic media such as hard disks, optical media such as compact disks (CD-ROM and CD-RW) and digital versatile disks (DVD and DVD±RW); flash memory devices; and other storage media. As used herein, the term “storage media” means a physical object for storing information. The term storage media does not encompass transitory media such as signals and waveforms.

Information stored in the storage 330 may include a driver database 332. The driver database 332 may contain information pertaining to drivers (or operators) of PEV that may access the computing device 300. The driver database 332 may include information, for each driver, such as a user name or other unique identification, an associated password, address information, billing information, a driver's real name, a driver's email address, a driver's mobile telephone number and a preferred method of contact. Additional or less information pertaining to a driver may be maintained by the driver database 332. For example, a driver's employment, VIP or group membership status may also be stored in the driver database 332.

The storage 330 may include an EVCS database 334. The EVCS database 334 may contain information pertaining to each of the EVCS that are serviced by the computing device 300. For example, in FIG. 2, each server 215, 225, 235 managed one or more EVCS within a respective EVCS management network 210, 220, 230. The EVCS database 334 may store information pertaining to the network address (if any) of each EVCS under its service, the capabilities of each EVCS, the current and projected use of each EVCS, any queue of users wishing to access each EVCS (in some cases a group of EVCS may be managed under a single queue, for example, at a location including multiple EVCS), the driver currently using each EVCS and any other information pertaining to each EVCS.

The storage 330 may include a network database 336 in addition to or instead of the driver database 332 and/or the EVCS database 334. The network database 336 may include data pertaining to communicating and managing transactions with one or more EVCS networks. The network database 336 may maintain authentication or other information necessary to enable this access. For example, the server 240 in FIG. 2 may include a network database containing information necessary to manage transactions between the EVCS management networks 210, 220, 230. The server 240 may not contain a driver database and/or an EVCS database since the server 240 may rely upon the servers 215, 225, 235 within the respective EVCS networks to store driver and EVCS information.

Information stored in the storage 330 may also include program instructions for execution by the processor 310. The program instructions may be in the form of one or more application programs, dynamic linked librarys (DLLs), or subroutines of any of the above. The program instructions may include an operating system such as, for example, variations of the Linux, Microsoft Windows®, Symbian®, Android®, and Apple® operating systems.

The communication interface 340 may include specialized circuits required to interface the computing device 300 with, for example, a network such as network 190 in FIG. 1, a PCD or a PEV. The communication interface 340 may include interfaces to one or more wired or wireless networks. The communication interface 340 may include, for example, one or more of an Ethernet™ interface for connection to a wired network, a Blue Tooth™ transceiver, a Zigbee™ transceiver, a WiFi™ transceiver, and/or a transceiver for some other wireless communications protocol. The communication interface 340 may be used to communicate information to and/or to receive information from a PCD or with a PEV that is or will be using an EVCS.

The operator interface 350 is used for an operator of the computing device 300 to interact with and to operate the computing device 300. The operator interface 350 may include a color or black-and-white flat panel display, such as a liquid crystal display, and one or more data entry devices such as a touch panel, a keyboard, and/or a mouse or other pointing device. The operator interface 350 may be or include a remote terminal, such as remote access via a secure shell connection or a specialized and authenticated application programming interface (API), that enables secure remote connections used to access the computing device 300.

Throughout the present patent, the term “automatic” or “automatically” shall mean that an operation occurs through the operation of a computer algorithm and without any human intervention. Throughout this patent, the term “storage media” shall explicitly exclude non-transitory media such as waveforms and signals.

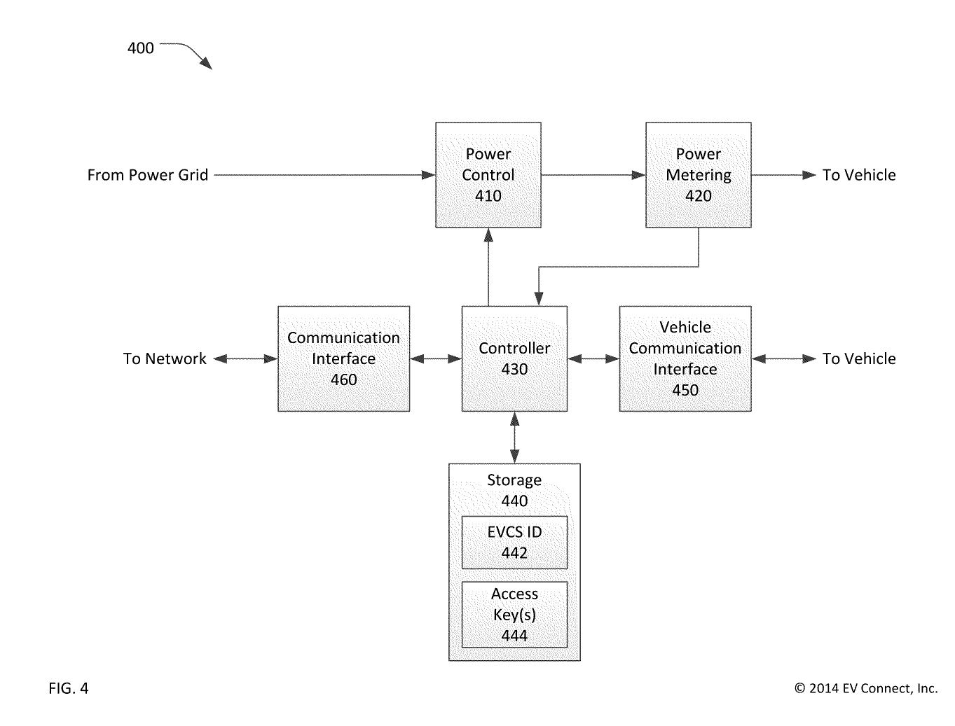

Referring now to FIG. 4, a block diagram of an EVCS 400 is shown. The EVCS may include power control 410, power metering 420, a controller 430, storage 440, a vehicle communication interface 450, and a communication interface 460. The storage 440 may store data including an EVCS ID 442 and access key(s) 444.

The power control 410 handles the receipt of power from the power grid by the EVCS 400. The power control 410 is instructed by the controller 430 to direct power through the power metering 420 to a vehicle being charged by the EVCS 400. The power control 410 may be, for example, a relay or solid-state switch to either turn on or turn off the charging power to the vehicle in response to an instruction from the controller 430. The power metering 420 measures the current passing through the power control and accumulates the total charge or energy delivered from the EVCS 400 to the vehicle. This power metering 420 may be used in determining the appropriate cost to the operator of the vehicle.

The controller 430, which may be a computing device including one or more processors and memory, may communicate with vehicles, such as a PEV, using the vehicle communication interface 450. The vehicle communication interface 450 may, for example, provide a pilot line signal to the PEV in accordance with SAE J1772™. The vehicle communication interface 450 may communicate with vehicles in some other manner such as power line communications or wirelessly. Through the vehicle communication interface 450, the controller 430 of the EVCS may receive information from the vehicle indicating the current charge state of a PEV, the rate at which that charge state is changing for a PEV and, as a result, be able to estimate a time-to-full charge state. The communication interface 460 may be used to communicate with the network and, by extension, with an EVCS server, such as the servers 215, 225, 235, in an EVCS network that includes the EVCS 400. The communication interface 460 may communicate with the network by way of a wired connection, such as an Ethernet connection. The communication interface 460 may communicate with the network by a wireless connection such as a WiFi local area network or a cellular telephone connection. The communication interface may communicate with the network directly or indirectly by way of a wireless connection to a driver's smart phone or other personal communication device.

The controller 430 may use the communication interface 460 to obtain data pertaining to drivers of PEVs, to obtain access to a queue of potential EVCS users, to transmit data pertaining to use of the EVCS by particular drivers and/or PEVs, and/or to communicate driver and billing information. For example, the EVCS may communicate to an EVCS server that the EVCS is no longer in use by the most recent driver. As a result, the EVCS server may respond with data pertaining to the next driver in the queue and to instruct the EVCS to limit access to only that next driver for a changeover period. The EVCS 400 may then use the communication interface 460 to notify the next driver, such as through simple message service or email, that the EVCS 400 is available for his or her use. Alternatively, the EVCS server may send such a notification in response to the EVCS communicating that the EVCS 400 is no longer in use.

The EVCS 400 also includes storage 440. The storage 440 provides nonvolatile storage of program instructions and data for use by the controller 430. Data stored in the storage 440 may include an EVCS ID 442 and one or more access key(s) 444. The EVCS ID 442 may be a unique identifier that is used to uniquely identify each EVCS in an EVCS network. The EVCS ID 442 may be, for example, a serial number, a MAC address, some other similar unique identifier, or a combination of two or more identifiers. The EVCS ID 442 may be derived by encrypting a serial number, a MAC address, some other unique identifier, or a combination of two or more identifiers. The EVCS ID 442 may be a random number or other identifier assigned by a remote device such as a server that manages an EVCS network containing the EVCS 400. The controller 430 may use the EVCS ID to uniquely identify the EVCS 400 to the network and/or PEVs using the communication interface 460 and the vehicle communication interface 450, respectively.

The access keys 444 may include one or more keys that allow a driver to charge a PEV at the EVCS 400. In order to charge a PEV, the driver must provide the EVCS 400 with an access key that matches one of the stored access keys 444. The access keys 444 may include, for example, an access key that allows unlimited use of the EVCS for charging and one or more restricted access keys that allow restricted use of the EVCS. A restrict use access key may be limited to, for example, a specific time window, a particular time of day, or one-time only use. A driver may present an access key to the EVCS 400, for example, by entering the access key using a keypad or other data entry device, or by communicating the access key wirelessly from a PCD.

The access key(s) 444 may also include one or more keys used by an administrator or maintenance personnel to, either remotely or directly at the EVCS 400, access maintenance and administrative features for the EVCS 400. For example, an administrator may be required to input an access key 444 in order to access administrator functions for the EVCS 400. In addition, the storage 440 may store software suitable to perform the various functions of the EVCS 400 described herein. The storage 440 may also store data pertaining to usage of various PEVs and associated users such that billing may be properly reported to, for example, an EVCS server. The storage 440 may also store a periodically updated queue of users waiting to gain access to the EVCS.

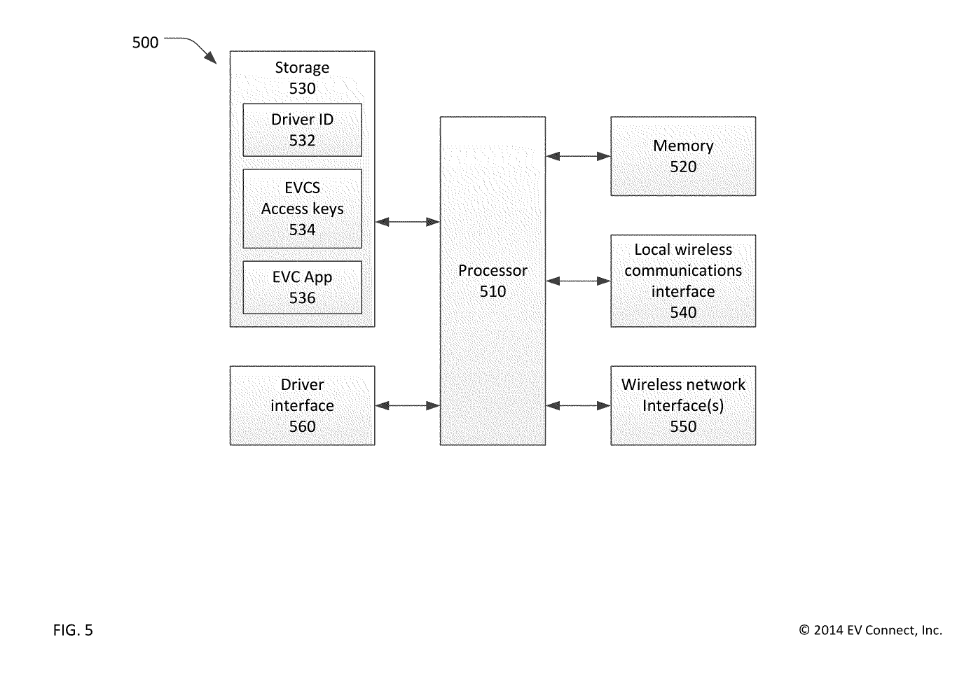

FIG. 5 shows a block diagram of a personal computing/communications device 500 (a “PCD”). The PCD 500 includes a processor 510, memory 520, storage 530, local wireless communications interface 540, wireless network interface(s) 550 and a driver interface 560. The driver interface 560 may be, for example, a touch screen display or some other combination of a display and a data input device such as a keypad and/or a pointing device.

The local wireless communications interface 540 may be, for example, a Bluetooth™, Zigbee™ or wireless local area network interface that can connect within a short distance of the PCD 500. This local wireless communications interface 540 may be used, for example, to connect to an EVCS, such as the EVCS 400, in order to exchange data pertaining to the EVCS.

The wireless network interface(s) 550 may be one or more interface usable to send and receive data over a long-range wireless communication network. This wireless network may be, for example, a mobile telephone network with data capabilities and/or a WiFi local area network or other wireless local area network.

The processor 510 and memory 520 serve substantially similar functions to the processor 310 and memory 320 in FIG. 3. The storage 530 may serve substantially similar functions to the storage 330 in FIG. 3. The storage 530 may store a driver ID 532, one or more EVCS access keys 534, and an electric vehicle charging application (EVC App) 536.

The driver ID 532 may be, for example, provided by an EVCS server or related web-based software. The driver ID 532 uniquely identifies the operator of the PCD 500 to an EVCS. The driver ID 532, therefore, may be used to enable EVCS charging to an intended operator of the PCD 500 and may enable billing for EVCS services to the correct individual. The driver ID 532 may be transmitted to an EVCS (to be forwarded on by the EVCS to an EVCS server) using the wireless network interface(s) 550.

The EVCS access keys 534 may enable a driver in possession of the PCD 500 to access an EVCS such as the EVCS 400 in order to charge a PEV. Upon receiving a request to charge a PEV, the EVCS may require the driver to submit both a driver ID and an Access Key, and may provide the charging service only if the submitted access key matches an access key stored within the EVCS.

When executed, the EVC App 536 may cause the PCD 500 to serve as an interface between the driver and the EVCS. For example, the EVC App may cause a graphical user interface (GUI) for the EVCS to be presented on the driver interface 560. The driver may then use the GUI to request charging services from the EVCS. The EVC App 536 may also cause the PCD to provide the charging service request, the driver ID 532 and an EVCS access key to the EVCS using either the local wireless communications interface 540 or a wireless network interface 550.

Description of Processes

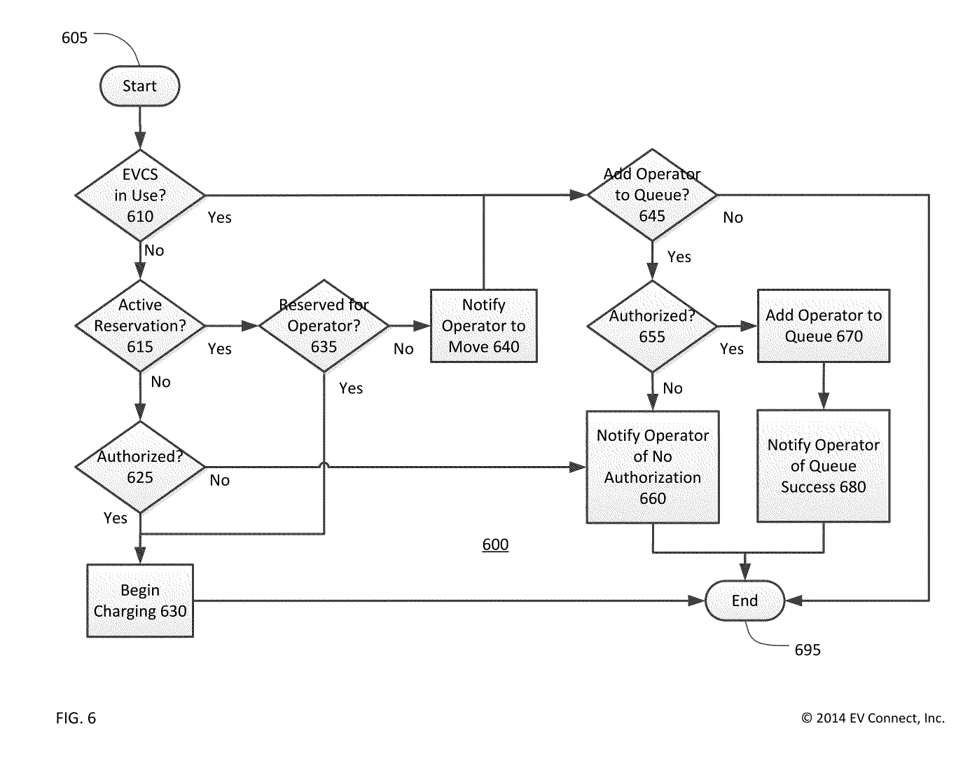

Referring now to FIG. 6, a flowchart 600 for the process of joining an EVCS queue. The process has a start 605 and an end 695, but many instances of this process may be taking place simultaneously with various vehicle operators at once. For example, multiple vehicle operators may be added to the queue at or near the same time, each following a process substantially similar to that shown in FIG. 6. The process shown in FIG. 6 may be implemented as an algorithm by the EVCS, and specifically by the controller 430 or may be implemented as an algorithm by a server, such as servers 215 and/or 240.

The process shown in FIG. 6 begins when a vehicle operator arrives at an EVCS and would like to charge. Arrival at or near an EVCS is preferred because it ensures utilization of the EVCS in ways that remote queuing do not. Specifically, usage of a vehicle operator's PCD to activate an EVCS may be required before an EVCS queue may be joined. This arrival may be determined based upon short-range wireless protocols, GPS or other location-tracking capabilities and other, similar, technologies.

After arrival at or near an EVCS at the start 605, a determination is made by a controller, such as controller 430 or servers 215 and/or 240, in the EVCS whether the EVCS is in use at 610. If the EVCS is not in use at 610, then a determination is made at 615 whether the EVCS has an active reservation. An active reservation means that the EVCS is being reserved (for a temporary, changeover period) for a particular vehicle operator. If a determination is made at 615 that the EVCS has an active reservation, a further determination is made at 635 whether or not the active reservation is held by the vehicle operator who arrived at the EVCS at 605. If a determination is made at 635 that the EVCS is being reserved for the arriving vehicle operator, then the vehicle of the arriving vehicle operator may be moved into the EVCS and the vehicle may begin charging at 630. If the EVCS is not being reserved for the arriving vehicle operator, then the arriving vehicle operator is notified that he or she must move at 640.

If there is no active reservation at 615, a determination is made, for example by the controller 430 or servers 215 and/or 240, whether the arriving vehicle operator is authorized at 625. In some cases, the vehicle operator may not be authorized to access the EVCS. The EVCS may always be reserved for employees, may be reserved for a predetermined group of users or, otherwise, may be made unavailable to some vehicle operators. If the vehicle operator is authorized, for example being a member of the public with a viable credit card in a public parking garage, then the vehicle operator is authorized to use the EVCS and the EVCS begins charging the electric vehicle at 630. If the arriving vehicle operator is not authorized, the operator may be notified of this fact at 660 and the process 600 may then end at 695.

If the EVCS is in use (“yes” at 610) or is being reserved for use by someone other than the arriving vehicle operator (“No” AT 635), then the arriving vehicle operator may be allowed to be added to a queue of potential users of the EVCS at 645. If the arriving vehicle operator elects not to be added to the queue, then the process ends at 695.

If the arriving vehicle operator elects to be added to the queue at 645, then a determination is made, for example by the controller 430, whether the arriving vehicle operator is authorized at 655. If the arriving vehicle operator is not authorized, either at 625 or at 655, then the arriving vehicle operator is notified that he or she is not authorized to use the EVCS and, therefore, not entitled to enter the queue, at 660. The process then ends at 695.

If the arriving vehicle operator is authorized to enter the queue at 655, then the arriving vehicle operator is added to the queue at 670 and notified that the process of queuing has been successful at 680. The notification process of successful queuing at 680, among other things, ensures that the notification process for informing the arriving vehicle operator of EVCS availability (e.g. at 840 below) and for asking a vehicle operator whose vehicle is currently occupying an EVCS to vacate the EVCS when his or her vehicle has charged (e.g. at 720 below) operates appropriately. In this way, the controller 430 or the server 215 and/or server 240 can ensure that the EVCS system has access to the vehicle operator before his or her vehicle is actually using the EVCS to charge.

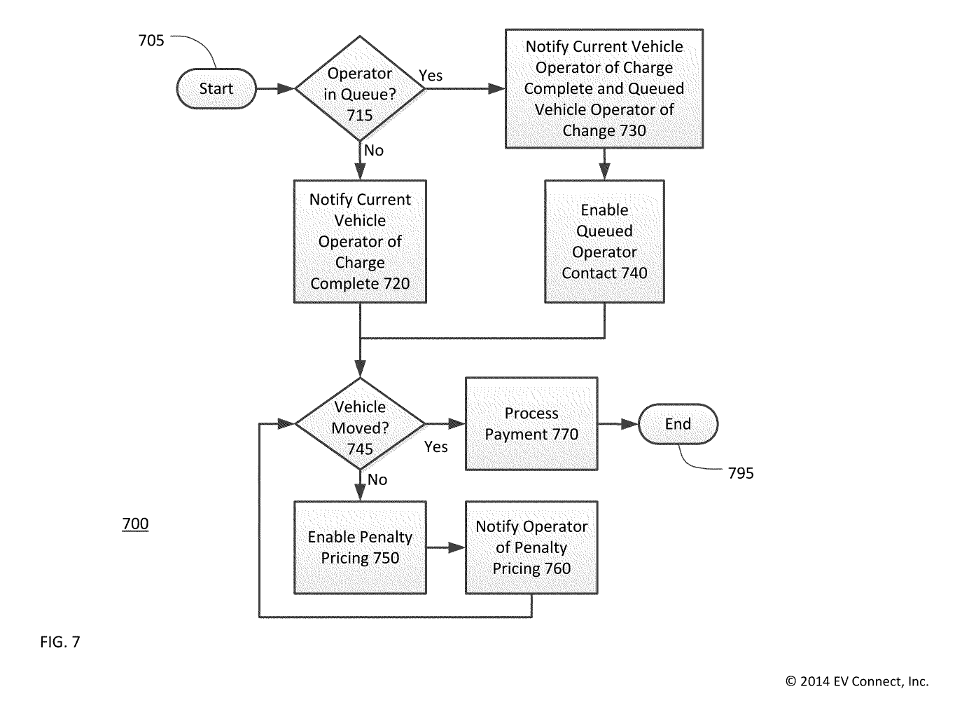

FIG. 7 is a flowchart for a process 700 of handling a completed electric vehicle charge. The process 700 begins at 705 and ends at 795. The process 700 shown in FIG. 6 may be implemented as an algorithm by the EVCS, and specifically by the controller 430 or may be implemented as an algorithm by a server, such as servers 215 and/or 240.

The process 700 begins when the EVCS system recognizes that a “current electric vehicle” (the vehicle currently connected to the EVCS) has completed charging. This may be detected by a voltage drop indicating that the current electric vehicle is no longer taking a charge. This may be indicated by a direct communications interface between the EVCS and the current electric vehicle. Communications across the interface may indicate that the current electric vehicle has reached a charged state. This may also be indicated based upon the completion of a time period, such as two hours, for which the EVCS was allocated to the current electric vehicle, after which the EVCS system must be made available for use by others.

Once a determination that the current electric vehicle has completed charging, the process 700 starts at 705. Next, a determination is made, for example by the controller 430 or servers 215 and/or 240, whether there is a queued vehicle operator in the queue at 715. If there is no queued vehicle operator in the queue at 715, then the current electric vehicle operator is notified that the charge is complete at 720. The current vehicle operator is also asked to move his or her vehicle from the EVCS in order to make it available to other, potential operators.

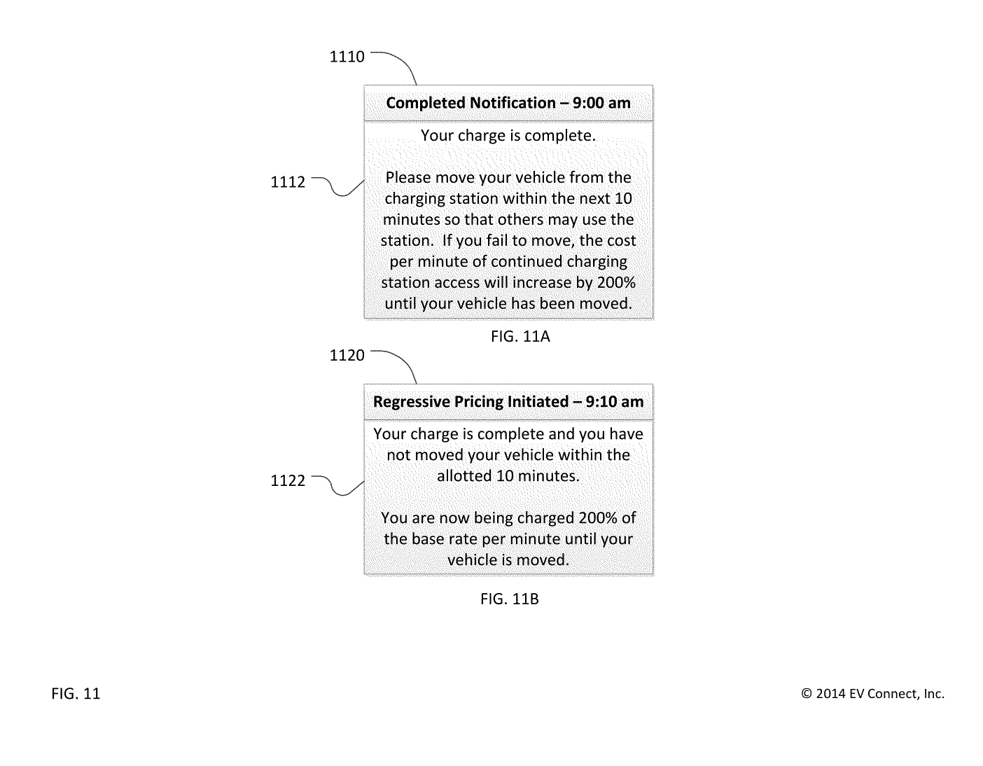

An example of such a notification to a current vehicle operator (the operator of the “current electric vehicle”) appears in FIG. 11A. The subject 1110 of the notification indicates that the charge is complete and includes the time. The content 1112 of the notification asks the current vehicle operator to move his or her vehicle and indicates that failure to move within 10 minutes will result in an increase in the price being charged for access to the EVCS. As described more fully below, these additional charges encourage EVCS users to vacate the EVCS when their vehicles are charged. The time allotted to a user to vacate his or her vehicle from the EVCS is called the “vacation time” or “vacation time period” herein.

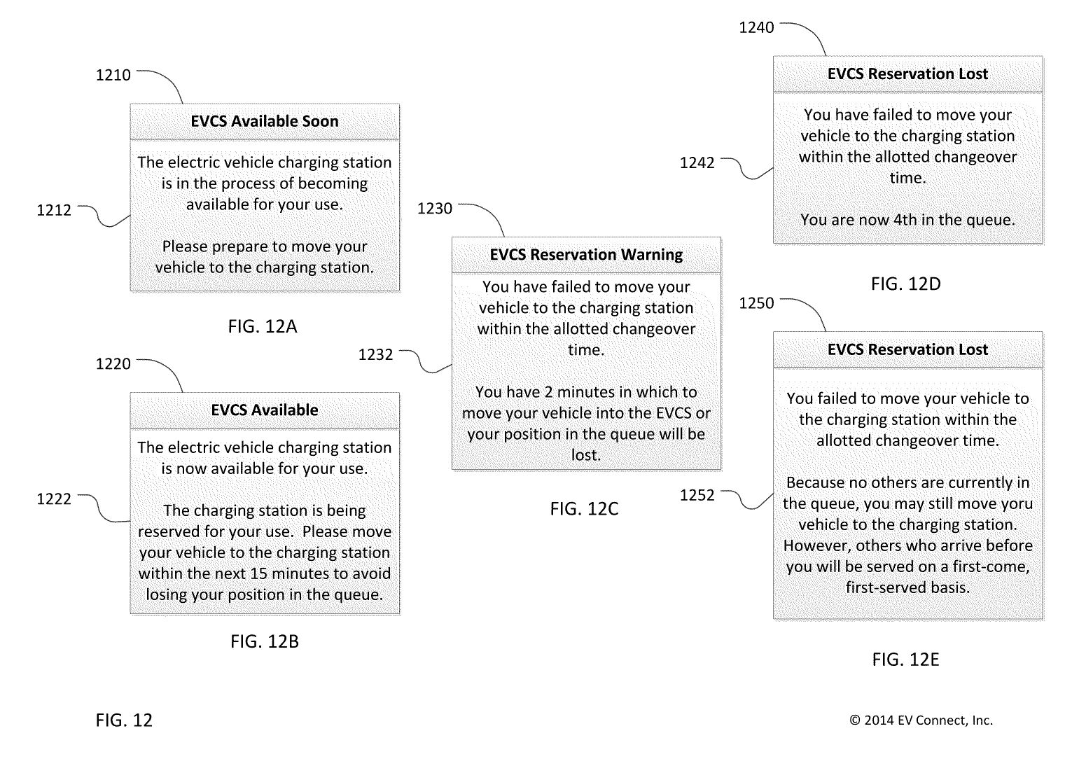

If there is queued vehicle operator in the queue at 715, then the current vehicle operator is notified that his or her charge is complete (as shown in FIG. 11A) and the queued vehicle operator is notified that the EVCS is in the process of being vacated by the prior occupant at 730. An example of such a notification appears in FIG. 12A. The subject 1210 indicates that the EVCS will be available soon and the content 1212 indicates that the EVCS will be available soon.

In addition, the queued vehicle operator may be empowered to anonymously contact the current vehicle operator in order to facilitate the current vehicle operator's vacation of the EVCS at 740. For example, the queued vehicle operator may be able to send anonymous SMS messages, emails or messages via an application operating on the queued vehicle operator and current vehicle operator's PCDs. In this way, the two may communicate one with another, without requiring either to know or share private contact information with one another.

Next, a determination is made at 745, for example by the controller 430, whether the current vehicle has moved within the allotted vacation time. This may be a determination that the current vehicle has or has not been unplugged from the EVCS. It may be a determination that a weight sensor no longer senses weight upon the parking space at EVCS. This may be determined using a camera, motion sensor, or proximity sensor or any combination of these.

If a determination is made at 745 that the current electric vehicle has not moved within the allotted vacation time, then the penalty pricing indicated in the notice sent at 720 will be enabled at 750. The example notice in FIG. 11A indicates that the pricing will be 200% of the base EVCS rate per minute. However, other pricing models may be used. For example, the current vehicle operator that has failed to vacate the EVCS may be barred from using the EVCS again for a period of time, such as a few weeks.

Alternatively, a pricing model in which the price slowly rises over the course of an hour or two, with periodic notices to the current vehicle operator, such that it slowly becomes prohibitively expensive to continue occupying the EVCS. This increase in price may be top-bound such that the total cost for an entire day does not exceed a predetermined sum, such as $50 or $200. In some cases, for example if the current vehicle operator is a member of a special group (employees, VIPs, etc.) the penalty pricing may not be enabled.

The current vehicle operator is notified of the penalty pricing at 760. An example of such a notice appears in FIG. 11B. The subject 1120 of the notice indicates the pricing penalty type as “regressive” and indicates the time. The content 1122 indicates the cost now being allotted for the EVCS and the reason for the additional cost. Once the notice is sent at 760, the system awaits movement of the current vehicle. Additional penalty pricing may be enabled at 750 with further, associated notices at 760.

Once a determination is made at 745 that the current vehicle has moved, payment for the charge is processed at 770. This may include the penalty pricing enabled at 740. The payment may be processed remotely or by the EVCS and may or may not rely upon payment methods provided at the EVCS. For example, payment may be made through the GUI provided on the PCD or may be input into a GUI on the PCD before a charge begins, with the payment only occurring once the vehicle charge is complete. For example, the current vehicle operator may receive a notification of the costs of the vehicle charge and an email or SMS receipt sent to the PCD or stored in an account associated with the current vehicle operator.

The process 700 then ends once the current vehicle has left the EVCS and the payment has been processed at 770.

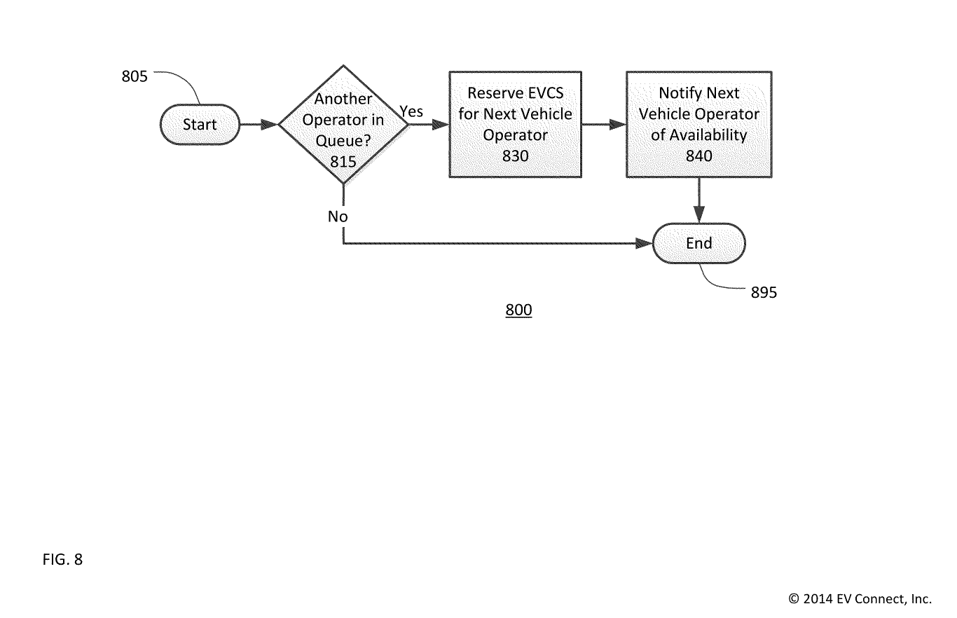

FIG. 8 is a flowchart for a process 800 of queue transition handling. The process 800 has a beginning at 805 and an end at 895. Many instances of the process 800 may be taking place simultaneously across a series of EVCS (for example a group of EVCS operating at a location). The process 800 may operate as an algorithm for a controller, such as controller 430 or may be implemented as an algorithm by a server, such as servers 215 and/or 240.

The process 800 starts at 805 when either a current electric vehicle is unplugged from an EVCS or otherwise moved from an EVCS or after completion of payment processing 770 in the process 700 of FIG. 7. The system, for example, the controller 430 or servers 215 and/or 240, determines whether there is at least one vehicle operator in the queue at 815. In the situation in which the process 700 described with respect to FIG. 7 is completing as the process 800 in FIG. 8 begins, it is possible that this determination has already been made at 715. In such a case, the system may refer to the results of the prior determination.

Otherwise, when a current electric vehicle is unplugged or otherwise moved from an EVCS or the process 800 begins, the determination that there is at least one vehicle operator in the queue at 815 is made. If there is no other vehicle operator in the queue at 815, then the process ends at 895.

If there is one or more vehicle operator in the queue at 815, then the EVCS will be reserved for the next vehicle operator (the vehicle operator at the top of the queue) at 830 for a predetermined period of time. This period of time may be set by an administrator or may be based, in part, upon group membership. For example, members of the public may be provided less time in which to move into an open EVCS than an executive at a company. The executive's schedule may be less-flexible than the public or than some other employees. As such, a longer time period (between meetings or the like) may be provided for a “VIP” to move than is provided to other potential EVCS users.

The next vehicle operator may be notified of the availability of the EVCS at 840 along with the movement period during which the EVCS is being reserved for the next vehicle operator. Such a notice appears in FIG. 12B. The subject 1220 of the notice indicates that the EVCS is available and the content 1222 indicates the movement period during which the EVCS is being reserved for the next vehicle operator.

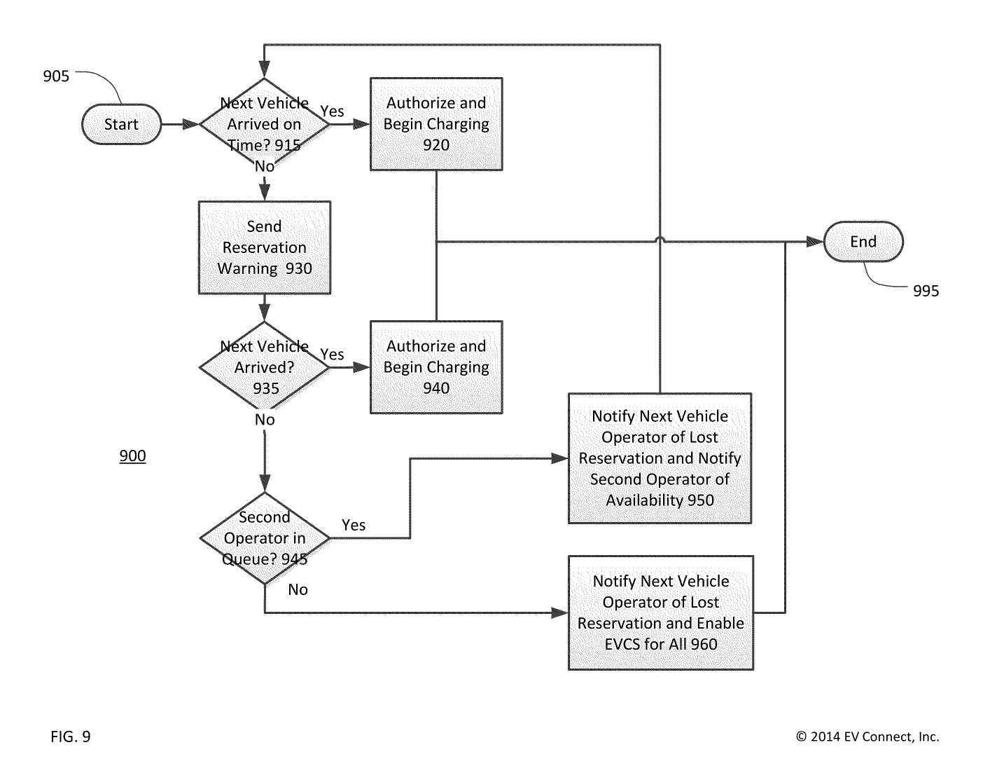

FIG. 9 is a flowchart for a process 900 of dealing with a missed EVCS reservation. The process 900 has a beginning at 905 and an end at 995. Many instances of the process 900 may be taking place simultaneously across a series of EVCS (for example a group of EVCS operating at a location). The process 900 may operate as an algorithm for a controller, such as controller 430 or may be implemented as an algorithm by a server, such as servers 215 and/or 240.

The process begins when an EVCS has been reserved for a next vehicle operator and the next vehicle operator has received notice that the EVCS is being reserved for their use. This may be, for example, after the notification sent at 840 of FIG. 8 and that process 800 ends at 895.

First, a determination is made whether the next vehicle operator for whom the EVCS is being reserved arrived on time for his or her reservation at 915. If soothe next vehicle operator arrived on time, the authorization process is completed and charging begins at 920 after which the process ends at 995.

If the next vehicle operator has not arrived on time at 915, then a reservation warning is sent to the next vehicle operator at 930. An example of such a reservation warning appears in FIG. 12C. The subject 1230 of the example warning indicates that it is a warning regarding the EVCS. The content 1232 of the warning indicates that the next vehicle operator has an additional movement period in which to move the electric vehicle into the EVCS before the reservation is lost. This additional movement period may be in addition to the movement period previously provided or may be only the remainder of the movement period previously provided. In such a situation, the reservation warning sent at 930 may be sent before the entire allotted movement period is elapsed.

Next, a determination is made whether or not the next vehicle operator has arrived during the additional movement period at the EVCS at 935. If so, the next vehicle operator is authorized and begins the charging process at 940, after which the process 900 ends at 995.

If a determination is made at 935 that the next vehicle operator has failed to arrive at the EVCS at 935, then a determination is made at 945 whether there is a second vehicle operator in the queue at 945. If so, then the next vehicle operator is notified of the lost reservation at 950 and the second vehicle operator is notified of the availability of the EVCS for his or her use. An example of such a notification to the next vehicle operator whose position in the queue has been lost appears in FIG. 12D. The subject 1240 of this notification indicates that the reservation has been lost and the content 1242 indicates that queued vehicle operator's new spot in the queue. An example of the message received by the second vehicle operator appears in FIG. 12B. The process 900 begins again with the second vehicle operator at 915.

If a determination is made at 945 that a second vehicle operator is not in the queue, then the next vehicle operator is notified that the reservation has been lost, but he or she is also notified that the EVCS is now available for use by anyone at 960. An example of such a notification appears in FIG. 12D. As seen in FIG. 12E, the subject 1250 of this notification indicates that the reservation has been lost, but the content 1252 indicates that the EVCS remains available for use by anyone.

At this point, the EVCS will accept all potential vehicle operators, not just the one for whom the EVCS is being reserved. A single or repeated failure to utilize the EVCS after making a reservation may result in loss of reservation privileges—the ability to enter the reservation queue—for a time period or indefinitely. The process ends a 995 after any vehicle has begun charging at 920 or 940 or when the EVCS has been made available for all at 960 because there are no more vehicle operators remaining in the queue.

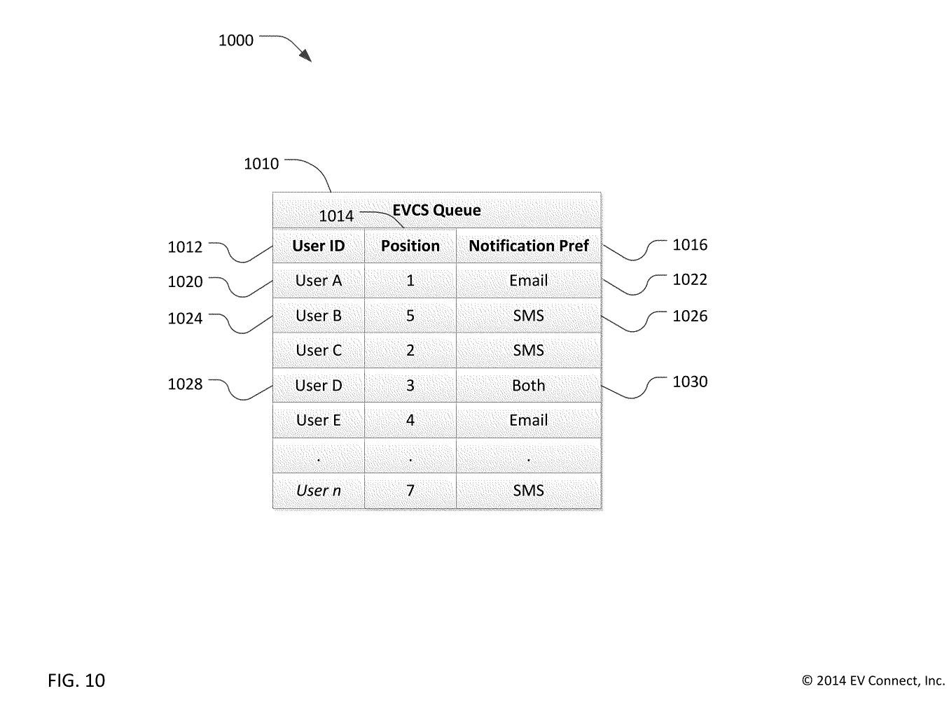

Referring now to FIG. 10, an example queue 1000 is shown in table 1010. The User ID 1012, position 1014 and notification preferences 1016 are shown in table 1010. The user notification preferences 1016 indicate how a particular vehicle operator would prefer to be contacted regarding their status in the queue—particularly when he or she is top of the queue. User A 1020 has chosen to be contacted via email 1022. User B 1024 has chosen to be contacted via SMS (simple message service) 826. User D 1028 has chosen to be contacted, simultaneously via both 1030.

Though only SMS and email are provided as options here, other methods may also be employed, such as notifications in a dedicated mobile application may “pop up” on a particular user's smartphone. Alternatively, a telephone call may be placed to a mobile or other telephone number associated with a particular user, the telephone call providing an automated voice message notification.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A method of management of an electric vehicle charging station comprising:
maintaining a plurality of requests to utilize the electric vehicle charging station in a queue defining an order of electric vehicles to be charged at the electric vehicle charging station;
automatically sensing that a first vehicle at the electric vehicle charging station and associated with a first vehicle operator has completed a charging process;
notifying the first vehicle operator that the charging process is completed and providing an allotted vacation time period in which the first vehicle operator may vacate the first vehicle from the electric vehicle charging station; and
automatically increasing the cost associated with continued charging of the first vehicle and enabling a second vehicle operator to anonymously contact the first vehicle operator to request that the first vehicle be moved if the first vehicle is not vacated from the electric vehicle charging station within the allotted vacation time.

2. The method of claim 1 further comprising:
automatically determining that a second vehicle associated with a second vehicle operator is in the queue;
notifying the second vehicle operator that the first vehicle operator has been asked to vacate the electric vehicle charging station;
determining that the first vehicle has vacated the electric vehicle charging station; and
notifying the second vehicle operator that the first vehicle has vacated the electric vehicle charging station.

3. (canceled)

4. The method of claim 1 wherein text within the anonymous contact is predetermined by an administrator of the electric vehicle charging station.

5. The method of claim 2 further comprising:
disabling the electric vehicle charging station for a movement time period allotted for the second vehicle operator to move the second vehicle to the electric vehicle charging station; and
reenabling the electric vehicle charging station during the movement time period only for the second vehicle operator.

6. The method of claim 5 further comprising reenabling the electric vehicle charging station after the movement time period for (1) a next vehicle in the queue if there is at least one additional vehicle in the queue and (2) any vehicle if there is not at least one vehicle operator in the queue.

7. The method of claim 5 further comprising notifying the second vehicle operator of the location of the electric vehicle charging station and a movement time period during which the electric vehicle charge station is reserved for use by the second vehicle operator.

8. The method of claim 2 wherein the second vehicle is at the top of the queue based upon a selected one of: (1) membership in a group with priority access to the electric vehicle charging station, (2) a willingness to pay a higher price for access to the electric vehicle charging station, (3) a willingness to accept throttled electrical output from the electric vehicle charging station for at least a part of a charging session.

9. The method of claim 1 further comprising:
determining that there are no electric vehicles in the queue before notifying the first vehicle operator that the charging process is completed and providing an allotted time in which the first vehicle operator may vacate the first vehicle from the electric vehicle charging station; and
enabling the electric vehicle charging station for any electric vehicle after the first electric vehicle has vacated the electric vehicle charging station.

10. An electric vehicle charging station management system comprising:
a computing device for:
determining that a first vehicle associated with a first vehicle operator has vacated an electric vehicle charging station;
determining that a second vehicle associated with a second vehicle operator is in a queue;
and
a communications system for:
notifying the second vehicle operator that the first vehicle operator has been asked to vacate the electric vehicle charging station,
notifying the second vehicle operator that the first vehicle has vacated the electric vehicle charging station.

11. The electric vehicle charging station management system of claim 10 wherein the computing device is further for enabling the second vehicle operator to anonymously contact the first vehicle operator to request that the first vehicle be moved.

12. The electric vehicle charging station management system of claim 11 wherein text within the anonymous contact is predetermined by an administrator of the electric vehicle charging station.

13. The electric vehicle charging station management system of claim 10 wherein the computing device is further for:
disabling the electric vehicle charging station for a movement time period allotted for the second vehicle operator to move the second vehicle to the electric vehicle charging station; and
reenabling the electric vehicle charging station during the movement time period only for the second vehicle operator.

14. The electric vehicle charging station management system of claim 13 wherein the computing device is further for reenabling the electric vehicle charging station after the movement time period for (1) a next electric vehicle in the queue if there is at least one additional vehicle in the queue and (2) any vehicle if there is not at least one vehicle operator in the queue.

15. The electric vehicle charging station management system of claim 14 wherein the communications system is further for notifying the second vehicle operator of the location of the electric vehicle charging station and a movement time period during which the electric vehicle charge station is reserved for use by the second vehicle operator.

16. The electric vehicle charging station management system of claim 10 wherein the second vehicle operator is at the top of the queue based upon a selected one of: (1) membership in a group with priority access to the electric vehicle charging station, (2) a willingness to pay a higher price for access to the electric vehicle charging station, (3) a willingness to accept throttled electrical output from the electric vehicle charging station for at least a part of a charging session.

17. The electric vehicle charging station management system of claim 10 wherein the computing device is further for:
determining that there are no electric vehicles in the queue before notifying the first vehicle operator that the charging process is completed and providing an allotted time in which the first vehicle operator may vacate the first vehicle from the electric vehicle charging station; and
enabling the electric vehicle charging station for any electric vehicle after the first vehicle has vacated the electric vehicle charging station.

18. The electric vehicle charging station management system of claim 10 wherein:
the computing device is further for:
automatically determining that a second vehicle associated with a second vehicle operator is in the queue, and
determining whether the first vehicle has vacated the electric vehicle charging station; and
the communication system is further for:
notifying the second vehicle operator that the first vehicle operator has been asked to vacate the electric vehicle charging station, and
after determining that the first vehicle has vacated the electric vehicle charging station, notifying the second vehicle operator that the first vehicle has vacated the electric vehicle charging station.

19. An electric vehicle charging station management system comprising:
at least one electric vehicle charging station for providing electric charge to one or more electric vehicles;
a sensor for sensing that a first vehicle associated with a first vehicle operator has completed a charging process;
a computing device for maintaining a plurality of requests to utilize the electric vehicle charging station in a queue defining an order of electric vehicles to be charged at the electric vehicle charging station;
a communications system for notifying the first vehicle operator that the charging process is completed and of an allotted vacation time period in which the first vehicle operator may vacate from the electric vehicle charging station and enabling the second vehicle operator to anonymously contact the first vehicle operator to request that the charging vehicle be moved; and
the computing device further for automatically increasing the cost associated with continued charging of the first vehicle when the first vehicle is not vacated from the electric vehicle charging station within an allotted vacation time.

20. The electric vehicle charging station management system of claim 19 wherein:
the computing device is further for:
automatically determining that a second vehicle associated with a second vehicle operator is in the queue, and
determining whether the first vehicle has vacated the electric vehicle charging station; and
the communication system is further for:
notifying the second vehicle operator that the first vehicle operator has been asked to vacate the electric vehicle charging station, and
after determining that the first vehicle has vacated the electric vehicle charging station, notifying the second vehicle operator that the first vehicle has vacated the electric vehicle charging station.

21. The electric vehicle charging station management system of claim 19 wherein text within the anonymous contact is predetermined by an administrator of the electric vehicle charging station.

22. The electric vehicle charging station management system of claim 19 wherein the computing device is further for:
disabling the electric vehicle charging station for a movement time period allotted for the second vehicle operator to move the second vehicle to the electric vehicle charging station; and
reenabling the electric vehicle charging station during the movement time period only for the second vehicle operator.

23. The electric vehicle charging station management system of claim 22 wherein the computing device is further for reenabling the electric vehicle charging station after the movement time period for (1) a next electric vehicle in the queue if there is at least one additional vehicle in the queue and (2) any vehicle if there is not at least one vehicle operator in the queue.

24. The electric vehicle charging station management system of claim 24 wherein the communications system is further for notifying the second vehicle operator of the location of the electric vehicle charging station and a movement time period during which the electric vehicle charge station is reserved for use by the second vehicle operator.

25. The electric vehicle charging station management system of claim 19 wherein the second vehicle operator is at the top of the queue based upon a selected one of: (1) membership in a group with priority access to the electric vehicle charging station, (2) a willingness to pay a higher price for access to the electric vehicle charging station, (3) a willingness to accept throttled electrical output from the electric vehicle charging station for at least a part of a charging session.

26. The electric vehicle charging station management system of claim 19 wherein the computing device is further for:
determining that there are no electric vehicles in the queue before notifying the first vehicle operator that the charging process is completed and providing an allotted time in which the first vehicle operator may vacate the first vehicle from the electric vehicle charging station; and
enabling the electric vehicle charging station for any electric vehicle after the first vehicle has vacated the electric vehicle charging station.
